(19) United States
(12) Patent Application Publication
(10) Pub. No.: US 2019/0126502 A1
(43) Pub. Date: May 2, 2019

(54) LIQUID FLUID DISPENSING ELECTRIC SHAVER

(71) Applicant: Alex Shlamowitz, Jupiter, FL (US)

(72) Inventor: Alex Shlamowitz, Jupiter, FL (US)

(21) Appl. No.: 16/172,348

(22) Filed: Oct. 26, 2018

Related U.S. Application Data
(60) Provisional application No. 62/577,858, filed on Oct. 27, 2017.

(51) Int. Cl. B26B 19/40; B26B 19/02; B26B 19/38

(52) U.S. Cl. CPC B26B 19/40; B26B 19/02; B26B 19/382; B26B 19/3886; B26B 19/3833

(57) ABSTRACT

An electronic device for use in shaving. The electronic shaving device is configured to dispense a liquid to aid in reducing harmful consequences, such as oil or dirt build up, or the formation of ingrown hairs, razor burn or other pimple formation associated with shaving.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 62/577,858, entitled “LIQUID FLUID DISPENSING ELECTRIC SHAVER” and filed on Oct. 27, 2017. The contents of the above referenced application are incorporated herein by reference in its entirety.

### FIELD OF THE INVENTION

The present invention relates to a device for use in personal hygiene; to an electronic device for use in shaving; and more particularly, to an electronic shaving device configured to dispense a liquid to aid in reducing harmful consequences associated with shaving.

### BACKGROUND OF THE INVENTION

Using a sharp tool for removing hair is well-known. Razor blades, both manual and electric, are known tools used for removing facial or other types of body hair. In typical operation, the razor blade is moved across a person's skin, thereby cutting the hair as the blade makes contact thereto.

### SUMMARY OF THE INVENTION

The present invention is directed to an electronic device for use in shaving. The electronic shaving device is configured to dispense a liquid to aid in reducing harmful consequences, such as oil or dirt build up, or the formation of ingrown hairs, razor burn or other pimple formation associated with shaving.

Accordingly, it is an objective of the invention to provide an improved personal hygiene device.

It is a further objective of the invention to provide an electronic shaving device configured to dispense a liquid to aid in reducing harmful consequences associated with shaving.

It is yet another objective of the invention to provide an electronic shaving device configured to dispense water to aid in reducing harmful consequences associated with shaving.

It is a still further objective of the invention to provide an electronic shaving device configured to dispense soap to aid in reducing harmful consequences associated with shaving.

It is a further objective of the invention to provide an electronic shaving device configured to dispense a hot or cold liquid to aid in reducing harmful consequences associated with shaving.

It is yet another objective of the invention to provide an electronic shaving device configured to dispense a liquid to aid in reducing harmful buildup of oil and/or dirt.

It is a still further objective of the invention to provide an electronic shaving device configured to dispense a liquid to aid in reducing ingrown hairs as a result of shaving.

It is a further objective of the invention to provide an electronic shaving device configured to dispense a liquid to aid in reducing razor burn associated with shaving.

It is yet another objective of the invention to provide an electronic shaving device configured to dispense a liquid to aid in reducing formation of acne and pimples associated with shaving.

It is a still further objective of the invention to provide an electronic shaving device configured to dispense a liquid to the razor blade head and/or the razor blade, thereby allowing a shaving functionality and a liquid dispersing functionality.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of an illustrative example of the electric shaver configured to dispense one or more fluids;

FIG. 2 is a schematic diagram of the electric shaver configured to dispense one or more fluids, illustrating one or more of the working components;

FIG. 3 is an illustrative example of a knob or dial;

FIG. 4 is a close-up view of the razor blade head, illustrating the fluid dispensing openings;

FIG. 5 is a perspective view of an alternative embodiment of the fluid dispensing electric shaver, illustrating removable compartments;

FIG. 6 is an alternative perspective view of the fluid dispensing electric shaver shown in FIG. 5;

FIG. 7 is a back view of the fluid dispensing electric shaver shown in FIG. 5;

FIG. 8 is a cross sectional view taken along lines 8A-8A in FIG. 7;

FIG. 9 is a perspective view of the fluid dispensing electric shaver, shown with fluid compartments removed;

FIG. 10 is a perspective view of the fluid dispensing electric shaver, with several internal compartments shown;

FIG. 11 is a back view of an embodiment of a shaving unit;

FIG. 12 is a cross sectional view taken along 12A-12A in FIG. 11;

FIG. 13 is an exploded view of the shaving unit illustrated in FIG. 11;

FIG. 14 is a partial view of an embodiment of a razor blade cord with two fluid hoses;

FIG. 15 illustrates an embodiment of a fluid dispensing unit; and

FIG. 16 illustrates an embodiment of a cutting element.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention, and is not intended to limit the invention to the specific embodiments illustrated.

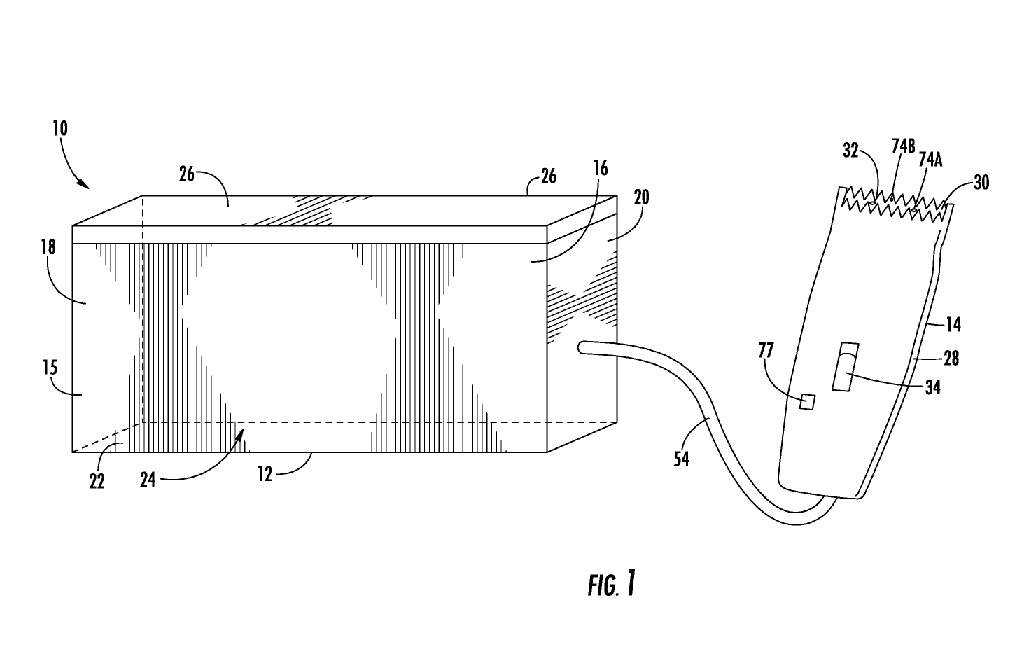

Referring to FIG. 1, an illustrative example of an electric shaver configured to dispense one or more fluids, referred to generally as a fluid dispensing electric shaver 10, is shown. The fluid dispensing electric shaver 10 comprises two main components, a fluid dispensing unit 12 and a shaving unit 14. The fluid dispensing unit 12 is configured to receive and hold one or more liquids, and contains a first pair of opposing side walls 15 and 16, and a second pair of opposing side walls 18 and 20. Walls 15, 16, 18 and 20 surround a bottom wall 22, thereby partially enclosing an interior region 24. A top wall 26 fully encloses the interior region 24. Preferably, the top wall 26 is removably secured to or attachable to the walls 15, 16, 18, and 20 so that one or more fluids can be placed within or taken from the interior region 24. The shaving unit 14 is configured to cut body hair and dispense one or more fluids, and comprises a main body 28 housing, one or more electrical components that drive functionality, i.e. cutting hair, a razor blade head 30, having one or more razor blades 32 to cut body hair, and a power on/off button 34, allowing a user the capability to power on or power off the shaving unit 14.

The fluid dispensing electric shaver 10, in accordance with the present invention, is designed to provide a close shaving unit that can be used to clean a user's face. The advantage of the device is that it provides both body hair cutting while providing the mechanism to dispense cleaning solutions in order to prevent oil and dirt build up, minimize ingrown hair, razor burn, or the development of acne and pimples, as a result of shaving. As such, the fluid dispensing electric shaver 10 is configured to both cut body hair and dispense fluids.

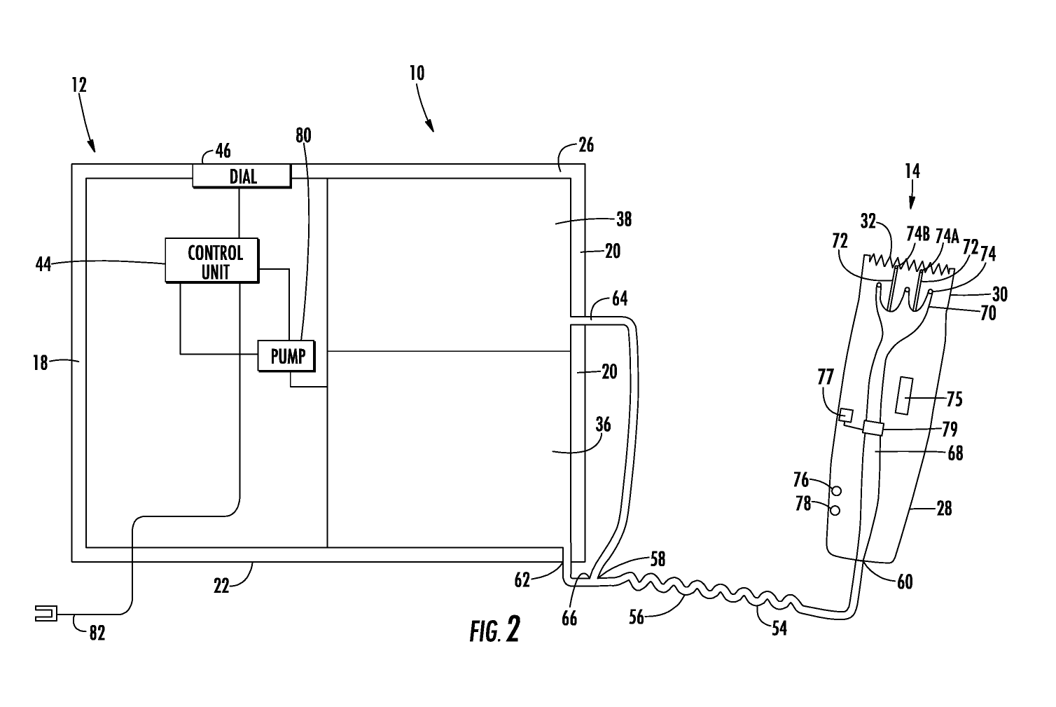

FIG. 2 provides a schematic diagram illustrating the various functional components of the shaving unit 14. As shown illustrated, the fluid dispensing unit 12 is composed with two separate fluid holding sections, a first water tank 36 configured to receive and hold water, and a separate second tank configured to hold a liquid solution that can be used to clean or hydrate a user's face. As such, the separate second tank 38 may hold soap solution, antibacterial solution, or hydrating skin liquid. Hydrating skin liquid is designed to increase the water content of the skin, and may contain one or more ingredients, extracts, antioxidants and moisture-binding ingredients to leave skin soft and hydrated. Hydrating skin liquid generally works by utilizing the powers of various hygroscopic ingredients, like humectants. A hygroscopic substance has the ability to attract water from its surroundings through absorption or adsorption, such as glycerin, honey and hyaluronic acid. As humectants, these substances absorb water from the air and bind it to the skin, facilitating hydration.

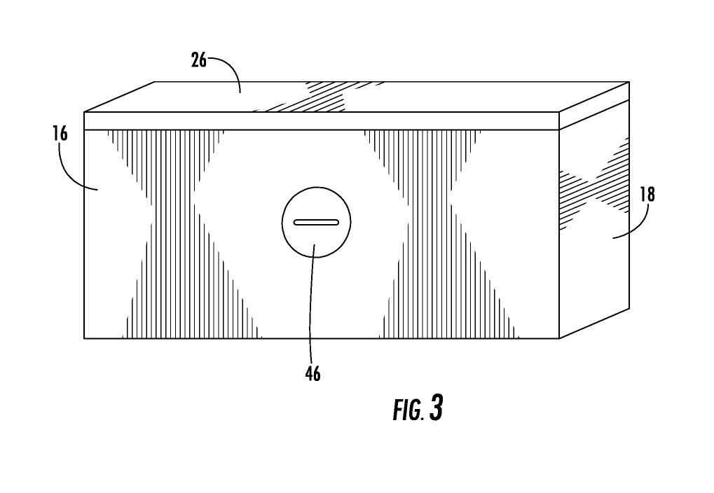

To provide the liquids, either the water stored in the first water tank 36 or the soap/antibacterial/hydrating liquid stored in the second tank 38, with thermal regulation, the user may add previously cooled or heated water to the fluid dispensing unit 12. The first tank 36 or the second tank 38 may be designed to be removable so that a user can take the tank to a water source, such as a sink and fill them up. The fluid dispensing unit 12 contains a control unit, such as a microprocessor 44. The microprocessor 44 may be a single integrated circuit (IC) or a few integrated circuits. A tactile device, such as a knob or dial 46, allows a user to control and manipulate the various functions associated with the fluid dispensing electric shaver 10. FIG. 3 illustrates an example of the knob or dial 46 integrated into the side wall 16. The user can easily change settings by rotation of the knob or dial 46.

The liquid(s) stored within the fluid dispensing unit 12 are transferred to the shaving unit 14 through cord 54, see FIGS. 1 and 2. The cord 54 may be retractable, or may contain extendable coils 56. The cord 54 is designed to have a first end 58 that connects to the fluid dispensing unit 12 and a second end 60 that connects to the shaving unit 14. The first end 58 may be connected to the first water tank 36 by a water tank connection portion 62. The water tank connection portion 62 draws water stored within the first water tank 36 out towards the shaving unit 14. The first end 58 may also be separately connected to the second tank 38 by connection to a second tank connection portion 64. The second tank connection portion 64 draws fluid, i.e. soap, stored within the second water tank 38 out toward the shaving unit 14. The fluid drawn from the first tank 36 and the fluid drawn from the second tank 38 mix together at a common junction point 66 and travel to the shaving unit 14 as a mixed fluid (water in combination with soap/antibacterial/hydrating liquid).

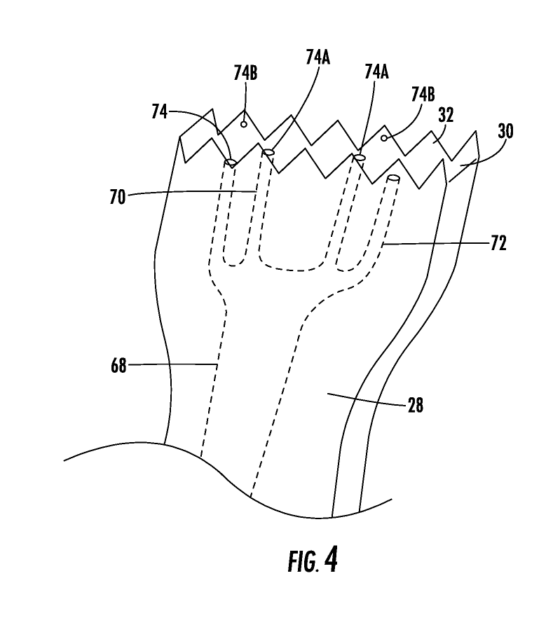

The mixed fluid is transferred into the main body 28 of the shaving unit 14 via a fluid transfer tube 68. The shaving unit fluid transfer tube 68 runs along the length of the main body 28 and branches off, forming one or more independent tubes 70, terminating at the razor head 30 or independent tubes 72 at, near or within the blades 32. The independent tubes 70 or 72 terminate in an opening 74A (within razor head) or 74B (within razor blade) sized and shaped to disperse the mixed fluid, see also FIG. 4. The main body 28 of the shaving unit 14 may contain a button layout 75 configured to change settings of the razor blade 32 to control speed or cutting length. The main body 28 of the shaving unit 14 may also contain green display lights 76 or red display lights 78 to indicate power on (green) or power off (red). Finally, fluid control button 77 may be operatively coupled to a fluid flowing control member, such as a valve 79, to control fluid flow. The fluid control button 77 may be configured to allow fluid to flow once a user presses the fluid control button 77, opening valve 79. Alternatively, the valve 79 may be placed in a continually open position to allow fluid to flow once the shaving unit 14 is operating, i.e. turned on. In this case, pressing the fluid control button 77 closes the valve 79, thereby preventing fluid flow.

The fluids, either the water or soap, exiting the first water tank 36 or the second tank 38, may be controlled by a pump 80. The control unit 44 may be programmable to control the amount, form dispersed (spray or mist), and/or the pressure of any fluid transferred from the fluid dispensing unit 12 to the shaving unit 14. The fluid dispensing unit 12 may be plugged into a source of power using an electrical plug 82.

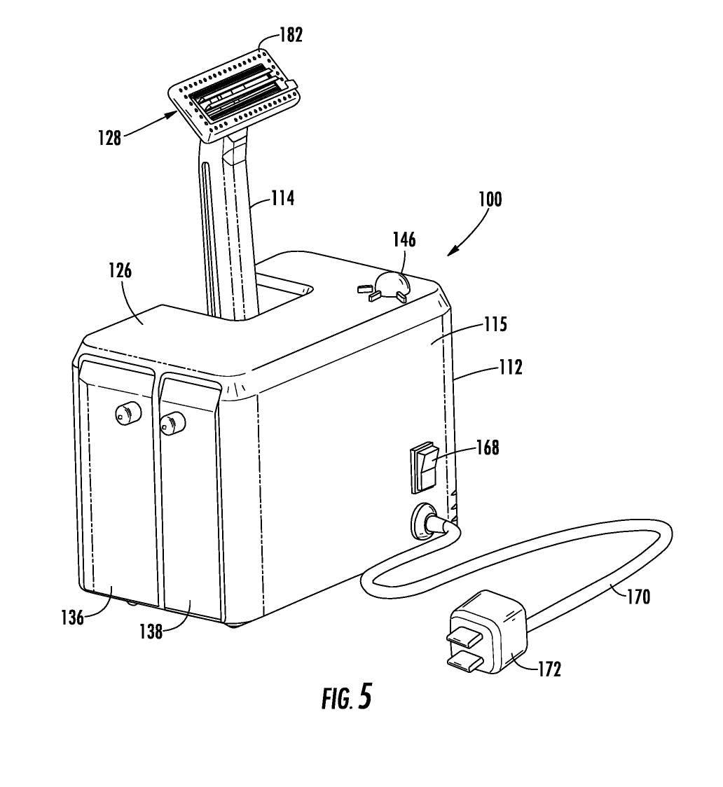

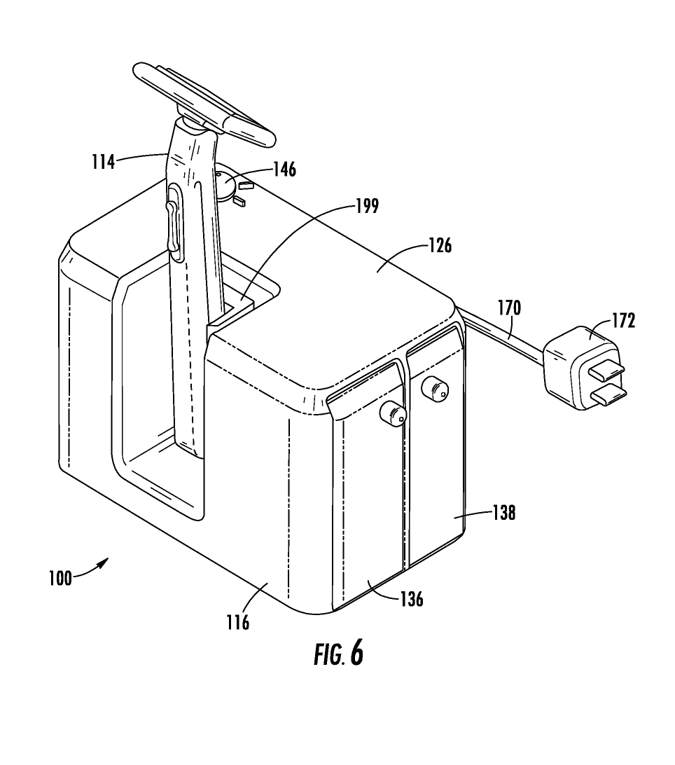

Referring to FIGS. 5-10, an alternative embodiment of the fluid dispensing electric shaver illustrated with removable components, referred to generally as fluid dispensing electric shaver 100, is shown. While not described in particular, any function, feature, element, or component described for the fluid dispensing electric shaver 10 may be applicable to the fluid dispensing electric shaver 100. Likewise, any function, feature, element, or component described for the fluid dispensing electric shaver 100 may be applicable to the fluid dispensing electric shaver 10.

The fluid dispensing electric shaver 100 comprises two main components, a fluid dispensing unit 112 and a shaving unit 114. The fluid dispensing unit 112 is configured to receive and hold one or more liquids and contains a first pair of opposing side walls 115 and 116, and a second pair of opposing side walls 118 and 120. Walls 115, 116, 118, and 120 surround a bottom wall 122, thereby partially enclosing an interior region 124. A top wall 126 fully encloses the interior region 124. The top wall 126, walls 115, 116, 118, and 120, or bottom wall 122 may be removable in order to access the interior region 124.

The shaving unit 114 is configured to cut body hair and dispense one or more fluids. The shaving unit comprises a fluid dispensing and cutting assembly unit 128 housing one or more components that drive functionality, i.e. cutting hair or dispensing fluids.

The fluid dispensing electric shaver 100, in accordance with the present invention, is designed to provide a close shaving unit that can be used to clean a user's face. The advantage of the device is that it provides both body hair cutting while providing a mechanism for dispensing cleaning solutions in order to prevent oil and dirt build up, razor burn, or the development of acne and pimples, and minimizes ingrown hair as a result of shaving. As such, the fluid dispensing electric shaver 100 is configured to both cut body hair and dispense fluids.

The fluid dispensing unit 112 preferably contains two separate fluid holding compartments, a first tank 136, referred to herein as the water tank 136 and a separate, second tank 138, referred to herein as the cleaning solution tank 138. The water tank 136 is configured to receive and hold a first liquid, such as water. The cleaning solution tank 138 is configured to hold a liquid solution that can be used to clean or hydrate a user's face. While the fluid dispensing electric shaver 100 is shown with two removable compartments, 3 or more compartments may be used, including one compartment that can be used to store or to mix the water and cleaning solution into a third solution.

The separate, second tank 138 preferably holds a soap solution, an antibacterial solution, or a hydrating skin liquid. Hydrating skin liquid is designed to increase the water content of the skin and may contain one or more ingredients, extracts, antioxidants and moisture-binding ingredients to leave skin soft and hydrated. Hydrating skin liquid generally works by utilizing the powers of various hygroscopic ingredients, like humectants. A hygroscopic substance has the ability to attract water from its surroundings through absorption or adsorption, such as glycerin, honey and hyaluronic acid. As humectants, these substances absorb water from the air and bind it to the skin, facilitating hydration. The water tank 136 and the separate, second tank 138, also referred to as a cleaning solution tank 138, are preferably removably attachable from the fluid dispensing unit 112, and are sized and shaped to fit within a compartment receiving area 137A and 136B, which are shown as cut out portions of the side wall 118, that are sized and shaped to maintain the water tank 136 and the cleaning solution tank 138 secured in placed when inserted therein.

The fluid dispensing unit 112 contains an electronics box 144 which may contain a microprocessor. The microprocessor (not shown) may be a single integrated circuit (IC) or a few integrated circuits and designed to control one or more components. A tactile device, such as a knob or dial 146, and rheostat (not shown) allows a user to control and manipulate the various functions associated with the fluid dispensing electric shaver 100, such as control of the speed of a high-pressure micro electric motor pump. As illustrated, the knob or dial 146 is integrated into the top wall 126, but could be located or positioned anywhere within the fluid dispensing electric shaver 100. The user can easily change settings by rotating and/or pressing of the knob or dial 146 to adjust for various levels of dispensing fluid pressure or speed. Alternatively, the fluid dispensing unit 112 may use a digital speed to control the sped of the high-pressure micro electric motor pump.

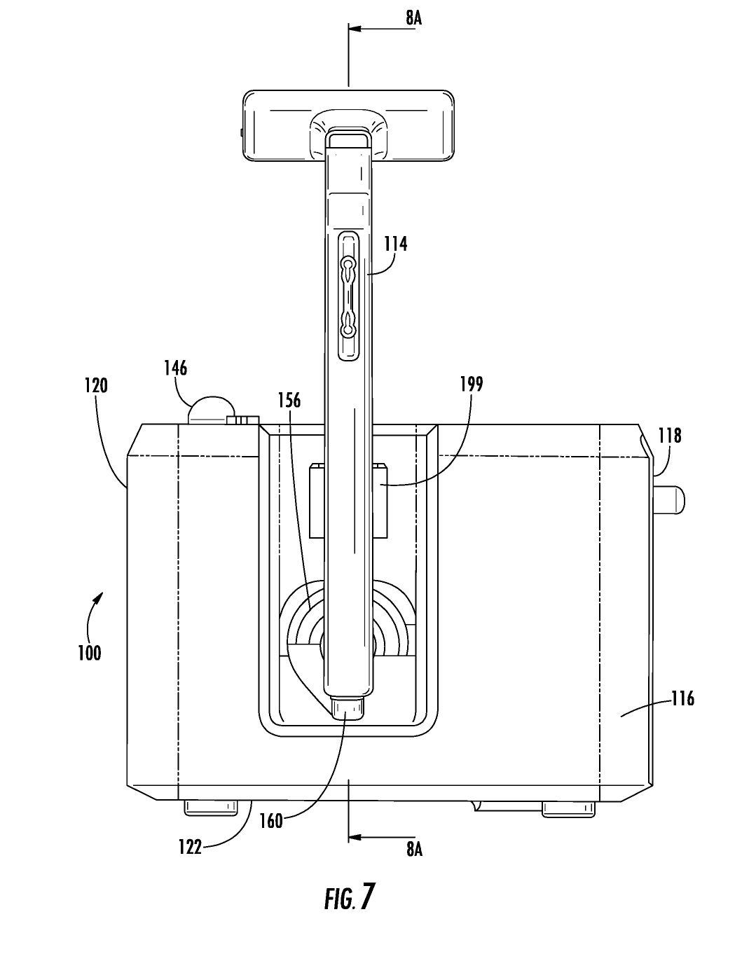

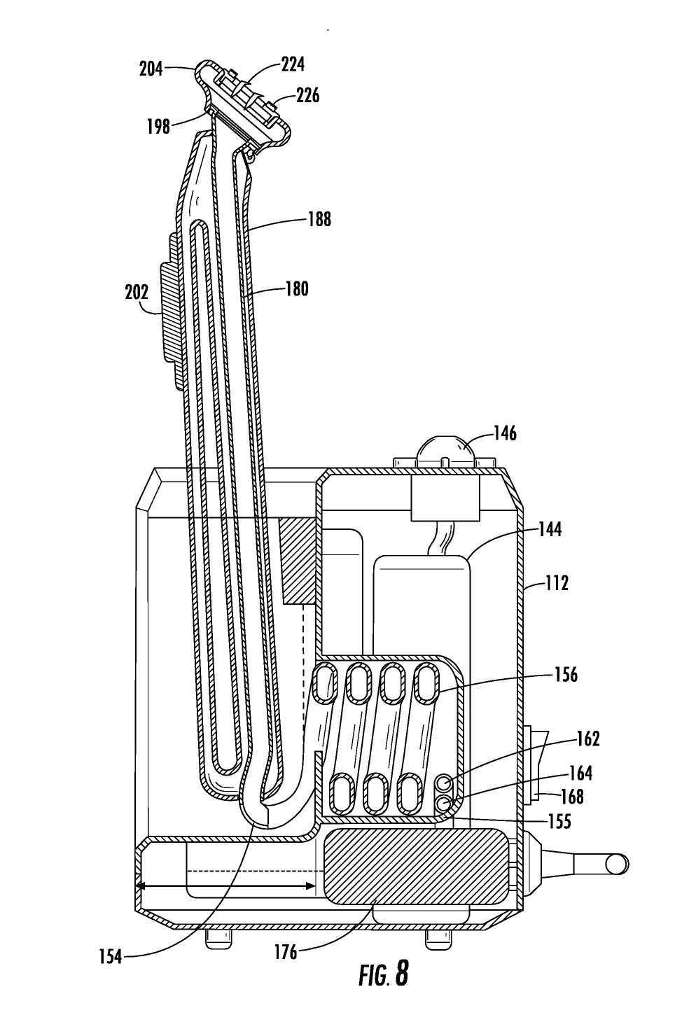

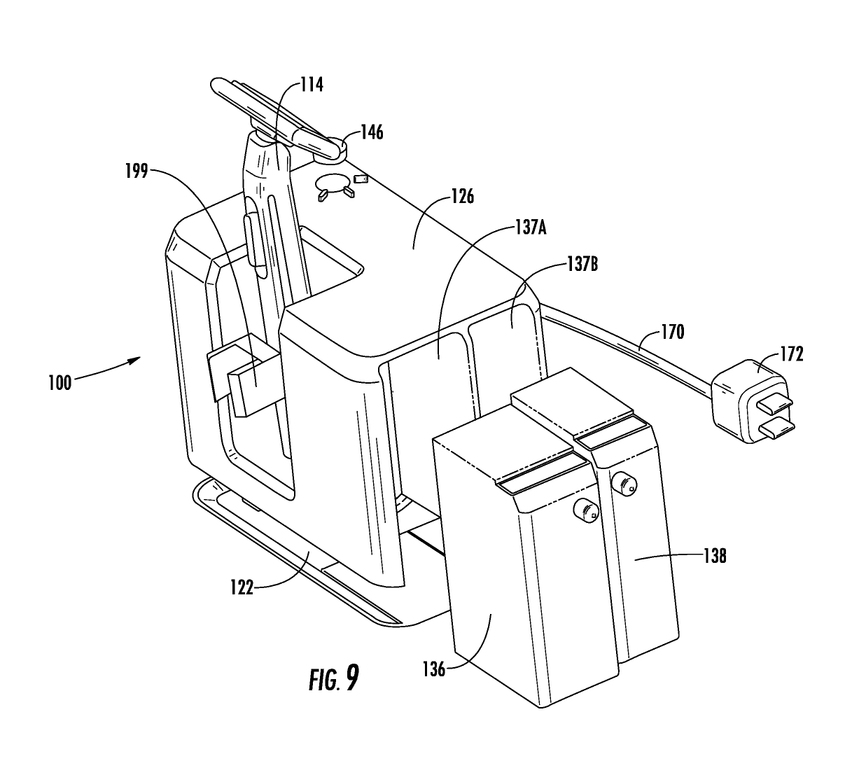

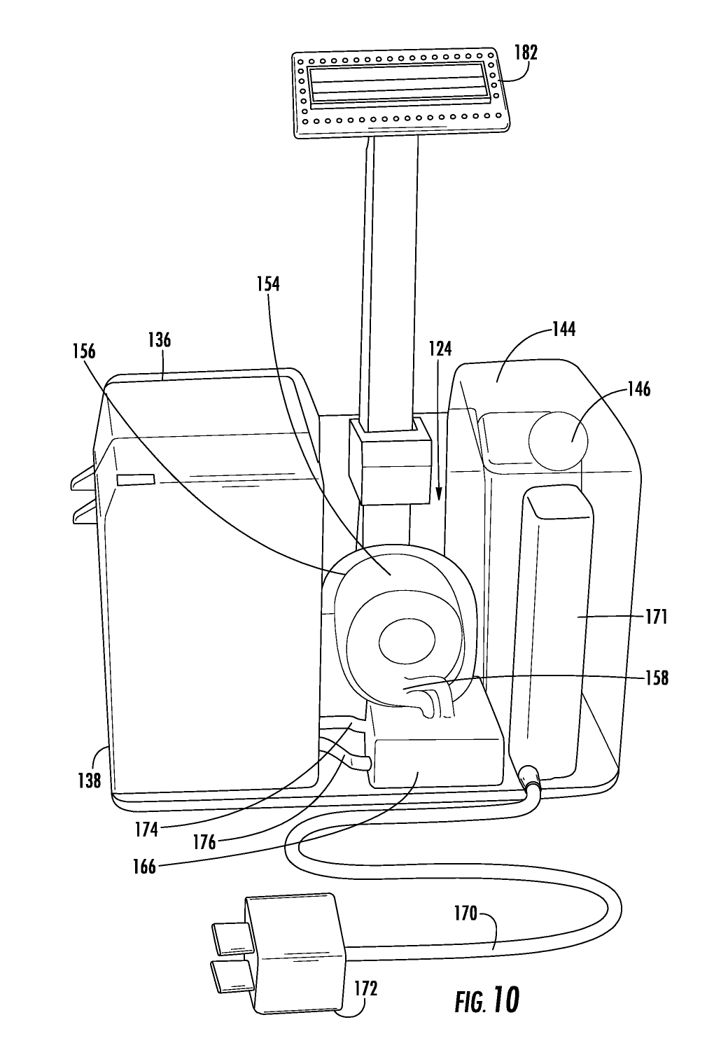

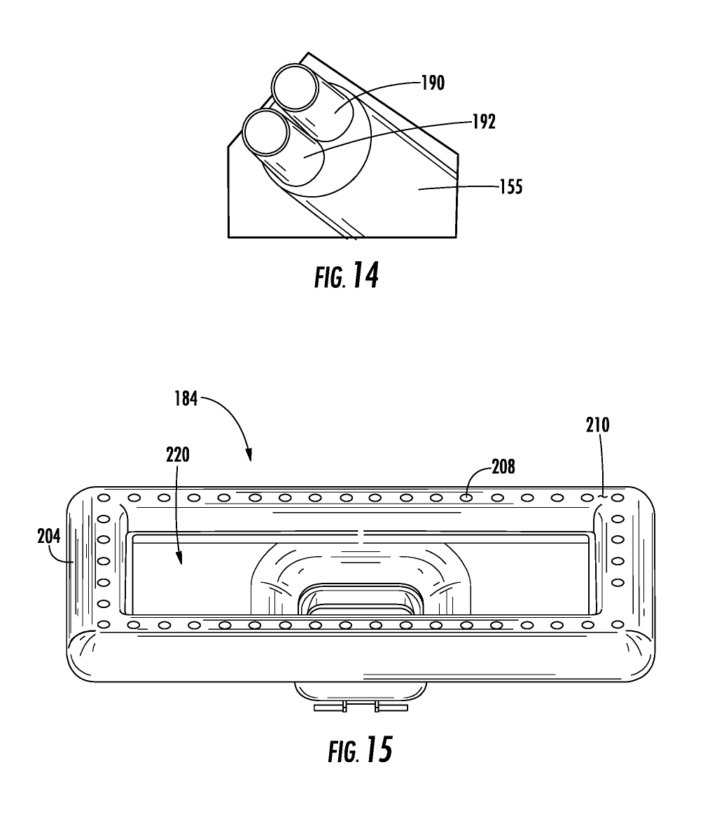

The liquid(s) stored within the fluid dispensing unit 112 are transferred to the shaving unit 114 through the hose 154, see FIGS. 8 and 10. Additionally, the razor cord 154 may include functional components such as wiring to drive razor blade cutting. The razor hose 154 may be retractable, or may contain extendable coils 156. The razor hose 154 is designed to have a first end 158 (FIG. 9) that connects to the fluid dispensing unit 112, and a second end 160 that connects to the shaving unit 114 (FIG. 7). The hose 154 may be operatively connected to the first water tank 136 by a water tank connection port 162 via a razor hose connector 155, see FIG. 14. The first end 158 may also be separately, operatively connected to the second tank 138 by connection to a second tank connection port 164. While not specifically illustrated, the fluid dispensing electric shaver 100 may be configured so fluid drawn from the first tank 136 and fluid drawn from the second tank 138 mix together at a common junction point and travel to the shaving unit 114 as a mixed fluid (water in combination with soap/antibacterial/hydrating liquid). Alternatively, the mixed fluid can be directed to a third storage tank (not shown) and then directed to the shaving unit 114 for dispersal.

A pump housing 166 housing one or more pumps, such as the high-pressure micro electric motor, provides a mechanism to move water and cleaning solution (Individually, using two separate pumps, or together using a single pump, but using separate conduits) from the water tank 136 and a or the cleaning solution tank 138 to the shaving unit 114. The fluid dispensing unit 112 may include a power button 168, power or charge cord 170 with electric outlet plug 172 for plugging into an electrical outlet, and a battery 171. Water from the water tank 136 is transferred out via tubing 174 and cleaning solution stored within the cleaning solution tank 138 is transferred out via tubing 176. The water tank 136 or the cleaning solution tank 138 may include a filter (not shown) for removing any unwanted materials or debris prior to being transferred to the shave unit 114

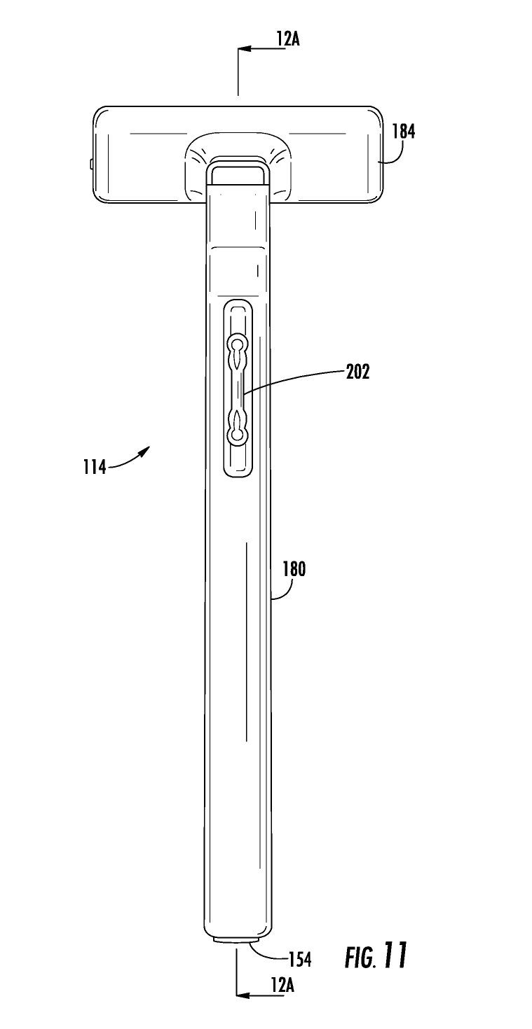

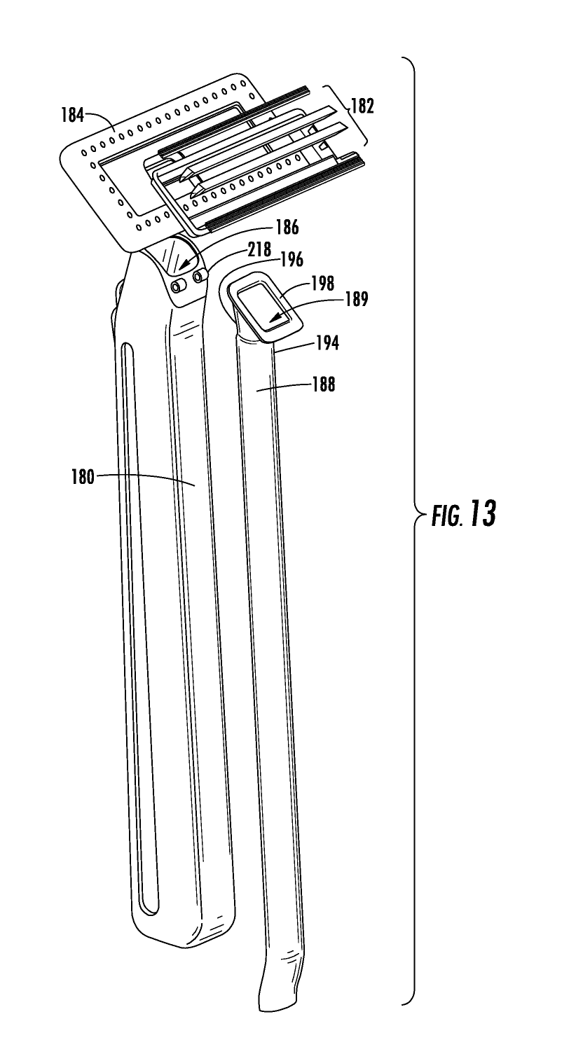

FIGS. 11-16 illustrate several aspects of the shaving unit 114. The shaving unit 114 comprises the fluid dispensing and cutting assembly unit 128 having a handle 180, a cutting element 182, and fluid dispensing unit 184. The handle 180 comprises a hollow interior region 186 sized and shaped to receive and store therein a hose housing unit 188, preferably made from a silicone material. The housing unit 188 contains a lumen or hollow interior 189 sized and shaped to store the razor blade hose 155, a water hose 190, and a cleaning solution hose 192, therein, see FIG. 14. The hose housing unit 188 may be designed to have a length that is the same or larger than the length of the handle 180. The water hose 190 and the cleaning solution hose 192 are illustrated as being independent from each other, but integrated with the razor blade cord 154. Alternatively, the razor blade cord 155, the water hose 190, and the cleaning solution hose 192 may be separated, thus having independent units. The hose housing unit 188 comprises an upper end 194, with an angled portion 196, terminating in a flanged portion 198 configured to secure to at least one portion of the fluid dispensing and cutting assembly unit 128. The hose housing unit 188 may include separate conduits, water conduit 191A or cleaning solution 191B, which allow for the water, the cleaning solution, or both to travel therethrough. The shaving unit 114 may be secured in place with a U-shaped bracket or clip 199.

The shaving unit handle 180 may contain a window 200 that allows a user to see at least a portion of the interior 186. A control button 202, slidable in multiple positions, may be designed to place the cutting element 182 or the fluid dispensing unit 184 in an ON/OFF mode, or to power ON/OFF 1) water injection, 2) cleaning solution injection, or 3) both water injection and cleaning liquid injection, thus dispersing water, cleaning solution, or combinations thereof. This may be accomplished by causing the pinching of the housing unit 188 or conduits 191A or 191B. Alternatively, control of the fluid may be accomplished by control of the pump in pump hosing 166.

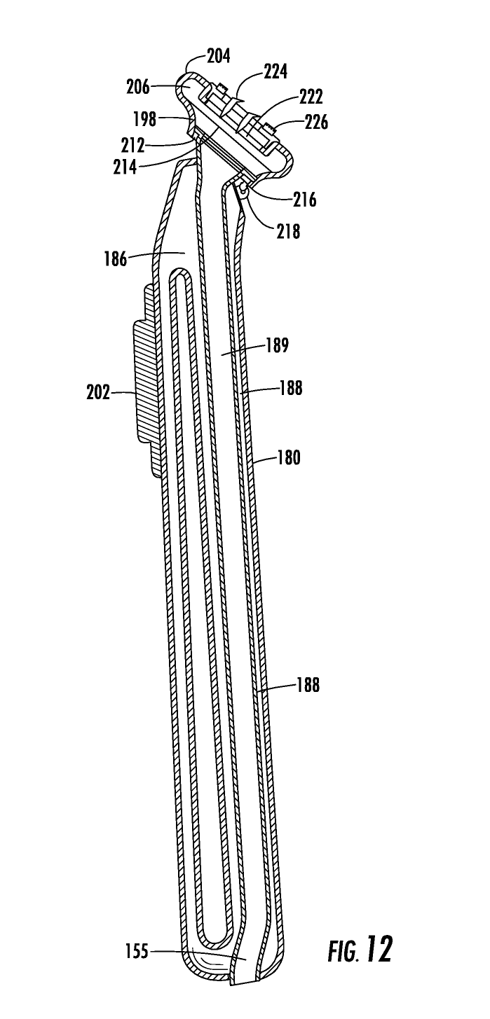

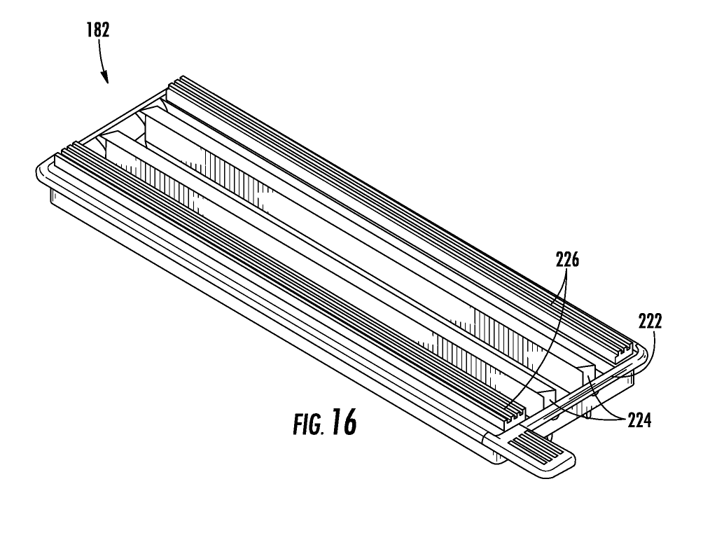

FIG. 15 illustrates an embodiment of the fluid dispensing unit 184 without the cutting element 182 attached thereto. The fluid dispensing unit 184 comprises a manifold 204 having an interior 206 (FIG. 12) for holding a liquid and a plurality of fluid dispensing apertures 208 arranged about surface 210. The fluid dispensing apertures 208 are illustrated to be arranged around the perimeter of the manifold 204, thus providing a fluid dispensing unit 184 that has fluid dispensing apertures 208 surrounding the cutting element 182 (see for example FIG. 5 or FIG. 10). The fluid dispensing apertures 208 are sized and shaped to allow for dispensing of fluid, such as water, cleaning liquid, or combinations thereof. The dispensing apertures 208 may be arranged in any pattern or arrangement to provide a particular fluid dispersal pattern. The manifold 204 may also contain a lip 212 on the undersurface 214 to help secure the flange 198 thereto. The manifold 204 may be pivotably connected to the shaving unit handle 180. An extended portion 216 of the manifold 204 may also be secured to an eyelet 218, see FIG. 12, thus providing an additional securing mechanism. A centrally positioned (i.e. not along the edges) manifold body opening 220 allows for connection with the cutting element 182, and may also provide a mechanism for dispersing fluid from an additional area other than from the fluid dispensing apertures 208.

FIG. 16 illustrates an embodiment of the cutting element 182. The cutting element 182 comprises a blade attachment frame 222, one or more cutting units 224, illustrated herein as a disposable steel blade, and optionally one or more lubricant strips 226. Lubricating strips 226 may be made of polyurethane or other similar materials impregnated with acrylic polymers. The polymer absorbs water, creating a lubricating surface that aids the blade glide across the surface of a user's face without snagging or cutting the skin.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An electric shaver configured to dispense one or more fluids comprising:
a fluid dispensing unit configured to receive and hold one or more liquids; and
a shaving unit configured to cut body hair and dispense one or more fluids.

2. The electric shaver configured to dispense one or more fluids according to claim 1 wherein said fluid dispensing unit comprises at least two compartments configured for receiving and holding a liquid.

3. The electric shaver configured to dispense one or more fluids according to claim 1 wherein said one compartment holds water and a second compartment holds a cleaning solution.

4. The electric shaver configured to dispense one or more fluids according to claim 2 wherein said at least two compartments are removable.

5. The electric shaver configured to dispense one or more fluids according to claim 1 wherein said shaving unit comprises a fluid dispensing and cutting assembly unit.

6. The electric shaver configured to dispense one or more fluids according to claim 1 wherein said fluid dispensing and cutting assembly unit comprises a fluid dispensing unit.

7. The electric shaver configured to dispense one or more fluids according to claim 6 wherein said fluid dispensing unit comprises a manifold having one or more fluid dispensing apertures configured to dispense water, a cleaning solution, or combinations thereof.

8. The electric shaver configured to dispense one or more fluids according to claim 7 wherein said manifold is pivotable.

9. The electric shaver configured to dispense one or more fluids according to claim 6 wherein said fluid dispensing and cutting assembly unit further comprises a handle and a cutting element.

10. The electric shaver configured to dispense one or more fluids according to claim 9 wherein said handle further includes a hose housing unit.

11. The electric shaver configured to dispense one or more fluids according to claim 10 wherein said hose housing unit contains a razor blade cord, a water hose, and a cleaning solution hose.

12. The electric shaver configured to dispense one or more fluids according to claim 10 wherein said water hose and said cleaning solution hose are integrated with said razor blade cord.

13. The electric shaver configured to dispense one or more fluids according to claim 6 wherein said cutting element further includes one or more cutting units.

14. The electric shaver configured to dispense one or more fluids according to claim 13 wherein said cutting units are disposable steel blades.

15. The electric shaver configured to dispense one or more fluids according to claim 3 wherein said cleaning solution is a soap, an antibacterial solution, or a hydrating liquid.

16. The electric shaver configured to dispense one or more fluids according to claim 3 wherein said fluid dispensing and cutting assembly unit is configured to dispense a first solution, a second solution, or a combination thereof.

17. The electric shaver configured to dispense one or more fluids according to claim 1 further including a tactile device to control and manipulate one or more functions.

18. The electric shaver configured to dispense one or more fluids according to claim 1 wherein said tactile device is a knob or dial.
